(19) United States
(12) Patent Application Publication
(10) Pub. No.: US 2008/0177759 A1
(43) Pub. Date: Jul. 24, 2008

(54) SYSTEM AND METHOD FOR CONTEXT-BASED TRAVERSAL OF DOCUMENT OBJECT MODEL DESCRIPTIONS

(76) Inventors: Ajit Sodhi, Irvine, CA (US); Sankarshana Madhavarao, Lake Forest, CA (US); Man Mohan Garg, Cerritos, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/626,816

(22) Filed: Jan. 24, 2007

(51) Int. Cl. G06F 17/30

(52) U.S. Cl. 707/100; 707/E17.005

(57) ABSTRACT

The subject application is directed to a system and method for context-based traversal of document object model descriptions. Electronic document data is first stored as a document object model description. An access request is then received from one or more unique associated applications, which reflects a request by an application to access the electronic document data. Predicate data is then received from the one or more unique applications, which data represents viewing characteristics of the one or more unique associated applications relative to the document object model description. The stored electronic document data is then parsed according to the received predicate data, thereby resulting in the generation of a document object model node. Thereafter, the electronic document data is traversed in accordance with the generated document object model node.

### BACKGROUND OF THE INVENTION

The subject application is directed to a system and method for context-based traversal of document object model descriptions. In particular, the subject application is directed to a system and method for generally accessing electronic documents with improved efficiency, and more particularly, to access document object model documents that are efficiently accessible by each of various applications.

It is common practice to store electronic documents in a standardized format so as to be accessible by various applications. There are many formats currently in use for electronic document storage. Without limitation, and by way of example only, such formats include the Microsoft Corporation's WORD *.doc format, Adobe System's portable document format, *.pdf. With the advent and growth of the Internet, there was a growing need to have electronic documents that are readily accessible by applications, particularly those that comprise web browsers. Current representative web browsers include Microsoft Corporation's INTERNET EXPLORER, Mozilla's FIREFOX, and Opera Software ASA's OPERA. This has prompted development of electronic document formats that are readily adaptable to access, display, and viewing over the World Wide Web, particularly through the use of web browsers that typically operate in an environment known as hypertext markup language (“HTML”).

The World Wide Web Consortium has published a specification for a document object module. The Document Object Model (“DOM”) is a platform- and language-neutral interface that allows programs and scripts to dynamically access and update the content, structure, and style of documents. DOM documents are suitably further processed and the results of that processing incorporated into a presented page.

Web language is written in standardized general markup language (“SGML”). SGML was originally designed to enable the sharing of machine-readable documents in large projects. It has also been used extensively in the printing and publishing industries, but its complexity has prevented its widespread application for small-scale general-purpose use. Extensible Markup Language (“XML”) is derived from SGML and is now in substantially broader use than SGML. An XML profile is a specific subset of SGML, designed to be simpler to parse and process than full SGML, and to have more lightweight itemization. XML is a simplification of SGML for general-purpose applications. XML has been used for a large number of applications, including applications such as XHTML, RSS, Atom XML-RPC, and SOAP.

Applications that access XML documents require a parser to interpret XML data. XML parsers include a functionality to build a tree, such as the World Wide Web Consortium document object model tree, in memory, either temporary or persistent. This parser is required to scan through the hierarchical tree-based representation of XML document object model documents. A typical parser requires that each tree must be traversed, node by node, until all nodes of interest to a particular application are identified. Multiple users or multiple applications identify different nodes of interest to isolate different views of a document. Thus, it is typically required that a copy be made for each use, and that a complete tree be traversed for each.

It would be advantageous to have a system and method that facilitated efficient viewing of electronic documents by various applications without the inefficiencies noted above, thereby facilitating more rapid document access with the use of fewer resources.

### SUMMARY OF THE INVENTION

In accordance with the subject application, there is provided a system and method for context-based traversal of document object model descriptions.

Further, in accordance with the subject application, there is provided a system and method for generally accessing electronic documents with improved efficiency.

Still further, in accordance with the subject application, there is provided a system and method for efficiently accessing document object model documents that are efficiently accessible by each of various applications.

Still further, in accordance with the subject application, there is provided a system and method which facilitate efficient viewing of electronic documents by various applications, thereby facilitating more rapid document access with the use of fewer resources.

Still further, in accordance with the subject application, there is provided a system for context-based traversal of document object model descriptions. The system includes storage means adapted for storing electronic document data as a document object model description and means adapted for receiving a request for access to stored electronic document data from an associated application. The system further includes means adapted for receiving predicate data corresponding to the associated application, wherein predicate data includes data representative of viewing characteristics of the associated application relative to the document object model description. The system also comprises means adapted for parsing stored electronic document data in accordance with received predicate data to generate a document object model node and means adapted for traversing electronic document data in accordance with a generated document object model node.

In one embodiment, the system further comprises means adapted for communicating the generated document object model node to a root of a sub tree of interest associated with the document object model description.

In another embodiment, the system also comprises means adapted for generating the stored electronic document as a run time instance of the document object model description.

In a further embodiment, the predicate data includes at least one selected node characteristic of the document object model description.

In yet another embodiment, the system also comprises means adapted for receiving a plurality of requests for access to stored electronic document data from a plurality of unique associated applications such that unique predicate data is associated with each such that each application traverses electronic document in accordance with its own characteristics. Preferably, the plurality of requests are chosen from a group consisting of a print request, a display request, and a facsimile request.

Still further, in accordance with the subject application, there is provided a method for context-based traversal of document object model descriptions in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of the system for context-based traversal of document object model descriptions according to the subject application;

FIG. 2 is a block diagram illustrating controller hardware for use in the system for context-based traversal of document object model descriptions according to the subject application;

FIG. 3 is a functional diagram illustrating the controller for use in the system for context-based traversal of document object model descriptions according to the subject application;

FIG. 4 is a flowchart illustrating a method for context-based traversal of document object model descriptions according to the subject application; and

FIG. 5 is a flowchart illustrating a method for context-based traversal of document object model descriptions according to the subject application.

### DETAILED DESCRIPTION OF THE PREFERRED EMBODIMENT

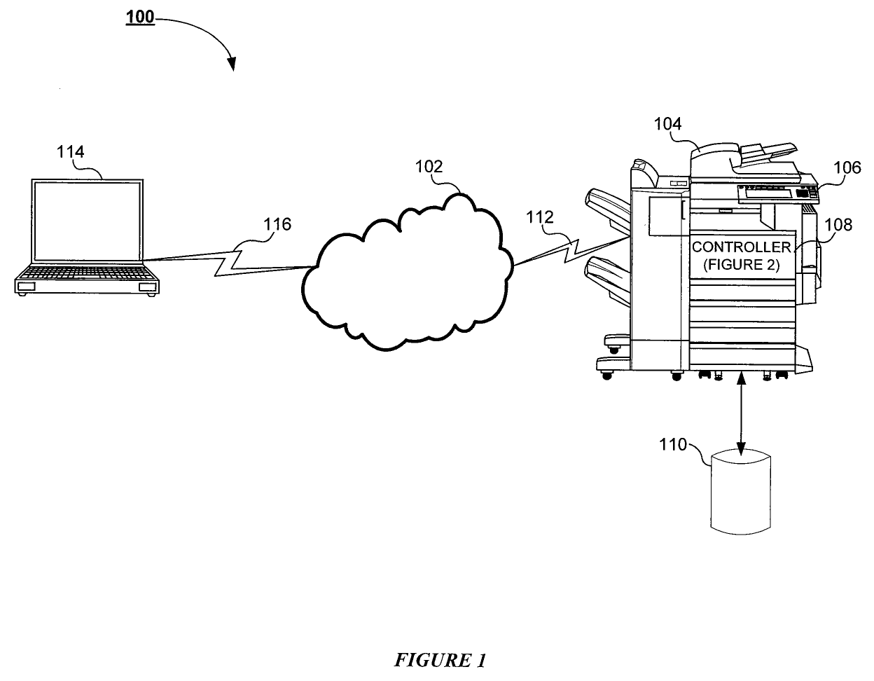

The subject application is directed to a system and method for a system and method for context-based traversal of document object model descriptions. In particular, the subject application is directed to a system and method for generally accessing electronic documents with improved efficiency. More particularly, the subject application is directed to a system and method that allows a user to efficiently access document object model documents that are efficiently accessible by each of various applications. Thus, it will be appreciated by those skilled in the art that the subject application is further directed to a system and method which facilitate efficient viewing of electronic documents by various applications, thereby facilitating more rapid document access with the use of fewer resources. It will become apparent to those skilled in the art that the system and method described herein are suitably adapted to a plurality of varying electronic fields employing user interfaces, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of the system 100 for context-based traversal of document object model descriptions in accordance with the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document processing device 104 is communicatively coupled to the computer network 102 via a suitable communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

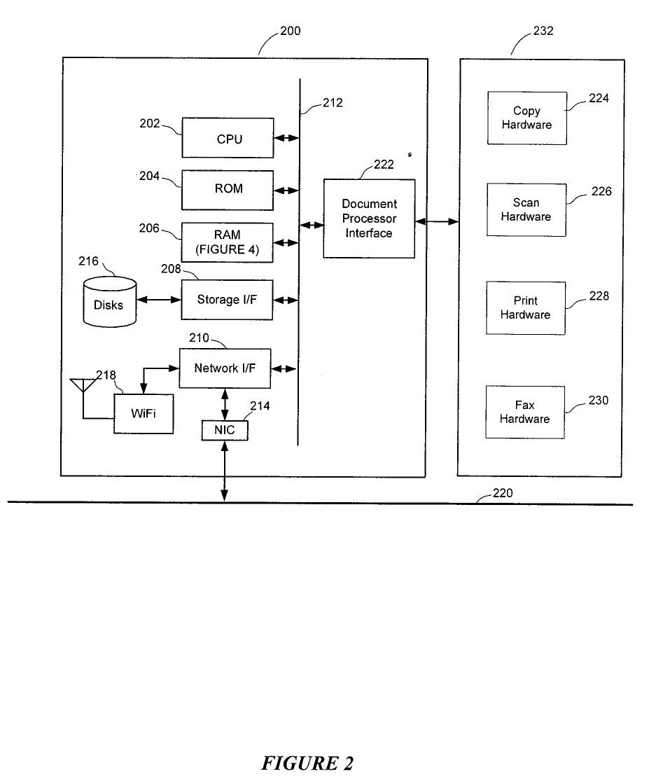

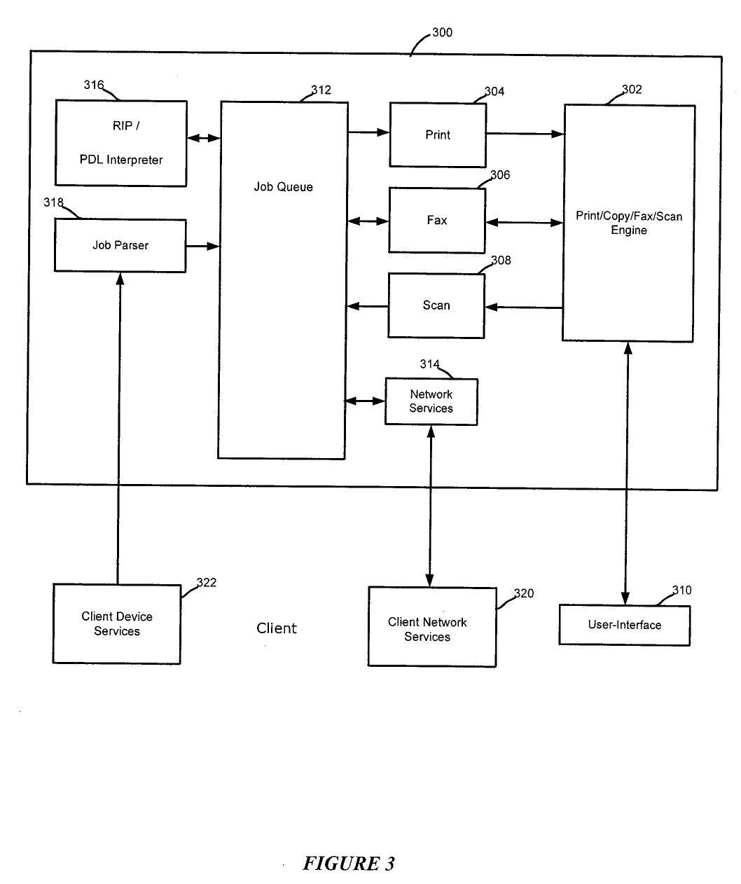

In accordance with the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system, known in the art, and thus the controller 108 is representative of such a general computing device and is intended as such when used hereinafter. Furthermore, the use of the controller 108 hereinafter is for the example embodiment only, and other embodiments, which will be apparent to one skilled in the art, are capable of employing the system and method for previewing document processing media of the subject application. The functioning of the controller 108 will better be understood in conjunction with the block diagrams illustrated in FIGS. 2 and 3, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store a document data, image data, electronic database data, or the like. It will be appreciated by those skilled in the art that while illustrated in FIG. 1 as being a separate component of the system 100, the data storage device 110 is capable of being implemented as internal storage component of the document processing device 104, a component of the controller 108, or the like, such as, for example and without limitation, an internal hard disk drive, or the like. In accordance with one embodiment of the subject application, the data storage device 110 includes electronic data representative of electronic document data in a document object model description.

The system 100 illustrated in FIG. 1 further depicts a user device 114, in data communication with the computer network 102 via a communications link 116. It will be appreciated by those skilled in the art that the user device 114 is shown in FIG. 1 as a laptop computer for illustration purposes only. As will be understood by those skilled in the art, the user device 114 is representative of any personal computing device known in the art, including, for example and without limitation, a computer workstation, a personal computer, a personal data assistant, a web-enabled cellular telephone, a smart phone, a proprietary network device, or other web-enabled electronic device. The communications link 116 is any suitable channel of data communications known in the art including, but not limited to wireless communications, for example and without limitation, Bluetooth, WiMax, 802.lla, 802.11b, 802.11g, 802.11(x), a proprietary communications network, infrared, optical, the public switched telephone network, or any suitable wireless data transmission system, or wired communications known in the art. Preferably, the user device 114 is suitably adapted to generate and transmit electronic documents, document processing instructions, user interface modifications, upgrades, updates, personalization data, or the like, to the document processing device 104, or any other similar device coupled to the computer network 102.

Turning now to FIG. 2, illustrated is a representative architecture of a suitable backend component, i.e., the controller 200, shown in FIG. 1 as the controller 108, on which operations of the subject system 100 are completed. The skilled artisan will understand that the controller 108 is representative of any general computing device, known in the art, capable of facilitating the methodologies described herein. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the controller 200 to communicate to other devices. Network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and network interface subsystem 210 is suitably accomplished via a bus data transfer mechanism, such as illustrated by bus 212.

Also in data communication with bus 212 is a document processor interface 222. Document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that a controller suitably operates any or all of the aforementioned document processing operations. Systems accomplishing more than one document processing operation are commonly referred to as multifunction peripherals or multifunction devices.

Functionality of the subject system 100 is accomplished on a suitable document processing device 104 that includes the controller 200 of FIG. 2, (shown in FIG. 1 as the controller 108), as an intelligent subsystem associated with a document processing device. In the illustration of FIG. 3, controller function 300 in the preferred embodiment includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 302 is suitably interfaced to a user interface panel 310, which panel allows for a user or administrator to access functionality controlled by the engine 302. Access is suitably enabled via an interface local to the controller, or remotely via a remote thin or thick client.

The engine 302 is in data communication with printer function 304, facsimile function 306, and scan function 308. These devices facilitate the actual operation of printing, facsimile transmission and reception, and document scanning for use in securing document images for copying or generating electronic versions.

A job queue 312 is suitably in data communication with print function 304, facsimile function 306, and scan function 308. It will be appreciated that various image forms, such as bit map, page description language or vector format, and the like, are suitably relayed from scan function 308 for subsequent handling via job queue 312.

The job queue 312 is also in data communication with network services 314. In a preferred embodiment, job control, status data, or electronic document data is exchanged between job queue 312 and network services 314. Thus, suitable interface is provided for network based access to the controller 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. Network services 314 also advantageously supplies data interchange with client side services 320 for communication via FTP, electronic mail, TELNET, or the like. Thus, the controller function 300 facilitates output or receipt of electronic document and user information via various network access mechanisms.

The job queue 312 is also advantageously placed in data communication with an image processor 316. The image processor 316 is suitably a raster image process, page description language interpreter or any suitable mechanism for interchange of an electronic document to a format better suited for interchange with device services such as printing 304, facsimile 306 or scanning 308.

Finally, the job queue 312 is in data communication with a parser 318, which parser suitably functions to receive print job language files from an external device, such as client device services 322. The client device services 322 suitably include printing, facsimile transmission, or other suitable input of an electronic document for which handling by the controller function 300 is advantageous. The parser 318 functions to interpret a received electronic document file and relay it to the job queue 312 for handling in connection with the afore-described functionality and components.

In operation, electronic document data is first stored as a document object model description. An access request is then received from an associated application, which reflects a request by the application to access the electronic document data. Predicate data is then received from the application. Preferably, the predicate data includes data representing viewing characteristics of the associated application relative to the document object model description. The stored electronic document data is then parsed according to the received predicate data, thereby resulting in the generation of a document object model node. Thereafter, the electronic document data is traversed in accordance with the generated document object model node.

In accordance with one example embodiment of the subject application, an application, such as a graphical user interface, web browser, or the like, accesses a stored electronic document in a document object model description. The skilled artisan will appreciate that the application is capable of operating via the user interface 106 associated with the document processing device 104, the user device 114 via the computer network 102, or the like. The application requests access to the document object model description stored in the data storage device 110 via any suitable means known in the art. The skilled artisan will appreciate that the request includes, for example and without limitation, a print request, a display request, a facsimile request, or the like. It will be understood by those skilled in the art that a plurality of requests for access to stored electronic document data from a plurality of unique associated applications such that unique predicate data is associated with each such that each application traverses electronic document data in accordance with its own characteristics. Regardless of the number of applications requesting access to the document data, each application then opens the document object model description and retrieves a document object representing the runtime instance of the document.

Next, the application communicates predicate data corresponding to one or more node characteristics, such as, for example and without limitation the set of constraints expressed on the nodes of the document, e.g., node name, node attribute value, or the like, to a document object model parser interface. The skilled artisan will appreciate that the document object model parser interface is any hardware, software, or combination thereof, suitably adapted to parse a document object model document. Preferably, the document object model parser consumes the predicates received from the application and returns a document object model node for communication to the root of the sub tree of interest. The application then receives the document object model node from the parser and communicates the node to the root of the sub tree of interest. The application then traverses the retrieved document object model document using the node. Thereafter, the application generates a display on the associated user interface 106, or the user device 114, according to the traversal of the document. The skilled artisan will appreciate that such a “smart” node enables the document to quickly traverse a document object model document without having to read through the document line-by-line to locate the next node.

In accordance with an example implementation of the subject application, the skilled artisan will appreciate that the document processing device 104 stores a listing of pending document processing operations in hierarchical document object model trees, such as those stored on the associated data storage device 110. Preferably, the job listing includes, for example and without limitation, various types of jobs including print jobs, scan jobs, facsimile jobs, electronic mail jobs, and the like. An application, such as the document processing device user interface 106 application, a web enabled user interface associated with the user device 114, or the like, is capable of presenting this job list in different ways to their associated users. That is, the user associated with the user interface 106 is capable of requesting the filtration of the job list to only the print jobs, whereas the user associated with the web-enabled user interface of the user device 114 requests filtration of the job list to only scan jobs. It will be appreciated by those skilled in the art that the mechanism by which these applications bind to the job list and render the job list to the users is generic and does not or should not be dependent upon the filter as specified by the corresponding user. The application, in applying the subject application, does not require the copying of the entire document object model document, but rather employs the nodes to transparently traverse the job list as if the job list were custom created solely for the user. That is, the traversal of the entire document object mode tree is based upon the preferences specified and not selecting node after node, thereby resulting in the node itself designating the next node to traverse to in the document, and so on.

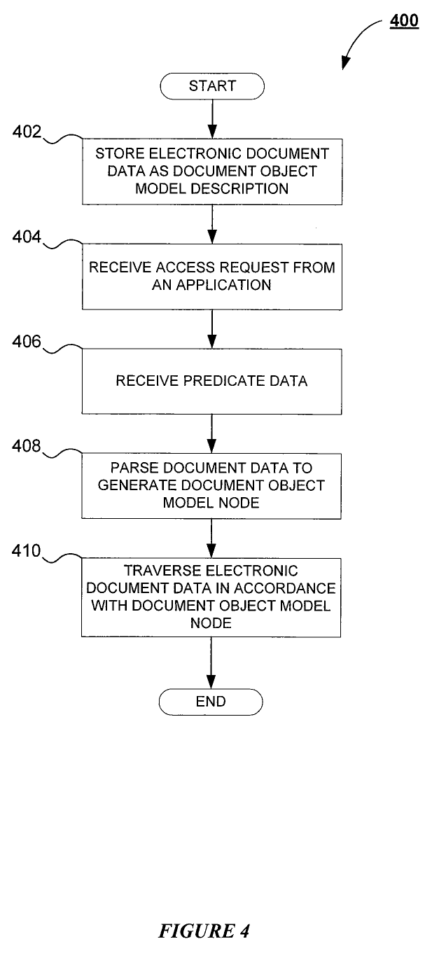

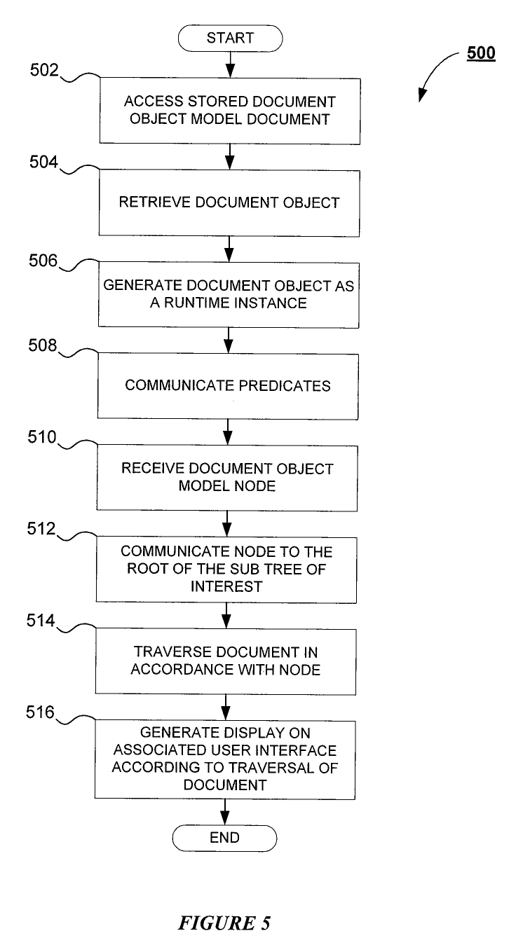

The skilled artisan will appreciate that the subject system 100 and components described above with respect to FIG. 1, FIG. 2, and FIG. 3 will be better understood in conjunction with the methodologies described hereinafter with respect to FIG. 4 and FIG. 5. Turning now to FIG. 4, there is shown a flowchart 400 illustrating a method for context-based traversal of document object model descriptions in accordance with the subject application. Beginning at step 402, electronic document data is stored as a document object model description. Preferably, the document object mode description is stored in the data storage device 110 associated with the document processing device 104. As will be appreciated by those skilled in the art, the document object model description is suitably accessible via the computer network 102 by a data processing device, such as the user device 114. At step 404, an access request to access the stored electronic document data is received from one or more unique associated applications. The access request suitably includes, for example and without limitation, a print request, a display request, a facsimile request, or the like. It will be understood by those skilled in the art that the subject application is capable of receiving a plurality of access requests for the electronic document data from the plurality of unique associated applications. The skilled artisan will appreciate that suitable applications include, for example and without limitation, a web-enabled user interface, e.g., a web browser on the user device 114, a display associated with the user interface 106 of the document processing device 104.

Predicate data is then received from the one or more unique applications at step 406, which includes data representing viewing characteristics of the applications relative to the document object model description. Preferably, the predicate data corresponds to one or more node characteristics, such as, for example and without limitation, the set of constraints expressed on the nodes of the document, e.g., node name, node attribute value, or the like, to a document object model parser interface. The skilled artisan will appreciate that the document object model parser interface is any hardware, software, or combination thereof, suitably adapted to parse a document object model document, such as, for example and without limitation, the controller 108, a backend component of the document processing device 104, a backend component of the user device 114, or the like. The electronic document data is then parsed by the document object model parser interface at step 408 according to the received predicate data to generate a document object model node. The electronic document data is then traversed according to the generated document object model node at step 410.

Referring now to FIG. 5, there is shown a flowchart 500 illustrating a method for context-based traversal of document object model descriptions in accordance with the subject application. The skilled artisan will appreciate that the flowchart 500 illustrates the operation of the subject application from the perspective of a unique associated application, and the methodology of FIG. 5 is equally applicable to a plurality of such unique applications requesting access to stored electronic document data. The method begins at step 502, whereupon an application requests access to electronic document data stored on the data storage device 110 as a document object model description. The application then opens the document at step 504 and retrieves a document object. The retrieved document object is then generated as a runtime instance of the stored electronic document data at step 506.

The application then communicates predicate data at step 508 to a document object model parser interface. A document object model node is then received by the application at step 510 from the document object model parser interface. Preferably, the document object model parser interface, as set forth above, consumes the predicate data, corresponding to node name, node attribute values, and the like, and returns the document object model node to the application. The application then communicates the received document object model node to the root of a sub tree of interest associated with the document object model description at step 512. The application then traverses the document object mode description at step 514 in accordance with the received node. Thereafter, the application generates display data on an associated user interface according to the traversal of the document object model description at step 516.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for context-based traversal of document object model descriptions comprising:
storage means adapted for storing electronic document data as a document object model description;
means adapted for receiving a request for access to stored electronic document data from an associated application;
means adapted for receiving predicate data corresponding to the associated application, which predicate data includes data representative of viewing characteristics of the associated application relative to the document object model description;
means adapted for parsing stored electronic document data in accordance with received predicate data to generate a document object model node; and
means adapted for traversing electronic document data in accordance with a generated document object model node.

2. The system for context-based traversal of document object model descriptions of claim 1 further comprising means adapted for communicating the generated document object model node to a root of a sub tree of interest associated with the document object model description.

3. The system for context-based traversal of document object model descriptions of claim 2 further comprising means adapted for generating the stored electronic document as a run time instance of the document object model description.

4. The system for context-based traversal of document object model descriptions of claim 2 wherein the predicate data includes at least one selected node characteristic of the document object model description.

5. The system for context-based traversal of document object model descriptions of claim 4 further comprising means adapted for receiving a plurality of requests for access to stored electronic document data from a plurality of unique associated applications such that unique predicate data is associated with each such that each application traverses electronic document in accordance with its own characteristics.

6. The system for context-based traversal of document object model descriptions of claim 5 wherein the plurality of requests are chosen from a group consisting of a print request, a display request, and a facsimile request.

7. A method for context-based traversal of document object model descriptions comprising the steps of:
storing electronic document data as a document object model description;
receiving a request for access to stored electronic document data from an associated application;
receiving predicate data corresponding to the associated application, which predicate data includes data representative of viewing characteristics of the associated application relative to the document object model description;
parsing stored electronic document data in accordance with received predicate data to generate a document object model node; and
traversing electronic document data in accordance with a generated document object model node.

8. The method for context-based traversal of document object model descriptions of claim 7 further comprising the step of communicating the generated document object model node to a root of a sub tree of interest associated with the document object model description.

9. The method for context-based traversal of document object model descriptions of claim 8 further comprising the step of generating the stored electronic document as a run time instance of the document object model description.

10. The method for context-based traversal of document object model descriptions of claim 8 wherein the predicate data includes at least one selected node characteristic of the document object model description.

11. The method for context-based traversal of document object model descriptions of claim 10 further comprising the step of receiving a plurality of requests for access to stored electronic document data from a plurality of unique associated applications such that unique predicate data is associated with each such that each application traverses electronic document in accordance with its own characteristics.

12. The method for context-based traversal of document object model descriptions of claim 11 wherein the plurality of requests are chosen from a group consisting of a print request, a display request, and a facsimile request.

13. A computer-implemented method for context-based traversal of document object model descriptions comprising the steps of:
storing electronic document data as a document object model description;
receiving a request for access to stored electronic document data from an associated application;
receiving predicate data corresponding to the associated application, which predicate data includes data representative of viewing characteristics of the associated application relative to the document object model description;
parsing stored electronic document data in accordance with received predicate data to generate a document object model node; and
traversing electronic document data in accordance with a generated document object model node.

14. The computer-implemented method for context-based traversal of document object model descriptions of claim 13 further comprising the step of communicating the generated document object model node to a root of a sub tree of interest associated with the document object model description.

15. The computer-implemented method for context-based traversal of document object model descriptions of claim 14 further comprising the step of generating the stored electronic document as a run time instance of the document object model description.

16. The computer-implemented method for context-based traversal of document object model descriptions of claim 14 wherein the predicate data includes at least one selected node characteristic of the document object model description.

17. The computer-implemented method for context-based traversal of document object model descriptions of claim 16 further comprising the step of receiving a plurality of requests for access to stored electronic document data from a plurality of unique associated applications such that unique predicate data is associated with each such that each application traverses electronic document in accordance with its own characteristics.

18. The computer-implemented method for context-based traversal of document object model descriptions of claim 17 wherein the plurality of requests are chosen from a group consisting of a print request, a display request, and a facsimile request.
